(19) United States
(12) Patent Application Publication
(10) Pub. No.: US 2020/0041693 A1
(43) Pub. Date: Feb. 6, 2020

(54) METEOROLOGY METHOD AND DEVICE AND ASSOCIATED COMPUTER PROGRAM PRODUCT

(71) Applicant: Extreme Weather Expertises, BREST (FR)

(72) Inventor: Christophe MESSAGER, BREST (FR)

(21) Appl. No.: 16/482,222

(22) PCT Filed: Jan. 29, 2018
(86) PCT No.: PCT/EP2018/052139

§ 371 Date: Jul. 30, 2019

(30) Foreign Application Priority Data
Jan. 30, 2017 (FR) 1750733

(51) Int. Cl. G01W 1/10; G01W 1/06; G01S 13/95; G01S 7/00; G01S 13/86; G01S 13/02

(52) U.S. Cl. CPC G01W 1/10; G01W 1/06; G01S 13/953; G01S 13/951; G01S 13/86; G01S 13/02; G01S 7/003

(57) ABSTRACT

The invention relates to a meteorology method for detecting and/or forecasting convective atmospheric systems (2) in the atmosphere (3) of a planet according to radiance data acquired by means of at least one radiance sensor (18) and being representative of the radiance emitted by a surface (6) of the planet and/or clouds (8) present in the atmosphere, and/or radar surface data acquired by means of at least one radar (20) and being representative of the state of the surface of the planet. The method comprises the detection of a convective atmospheric system (2) jointly according to both the radiance data and the radar surface data, and/or the digital forecasting of a convective atmospheric system (2) with digital assimilation of the radar surface data or jointly according to both the radiance data and the radar surface data.

The present invention relates to the field of meteorology detection and forecasting, in particular for the detection and forecasting of convective atmospheric systems, and in particular characteristics of these convective atmospheric systems (wind, gusts of wind, precipitations, temperatures, pressures).

A convective atmospheric system, also called “convective system”, designates a meteorological structure located in a geographical zone and having an intense activity characterized by ascending and descending winds that may be violent, which generate powerful winds and powerful gusts of wind on the surface of the planet (ground or sea). The temperatures and the associated pressures can vary quickly. The precipitations associated with a convective system are generally of high intensity and accumulation.

A convective system appears, evolves quickly and moves.

A convective system is in particular characterized by the presence of clouds of great vertical extension, this vertical extension varying quickly during the evolution of the convective system.

When a convective system is mature, its clouds form a Cumulonimbus assuming the form of an anvil-shaped cloudy column, extending from a first altitude of several hundreds of meters from the surface of the planet to a second altitude that may reach several kilometers.

Aside from cyclones, convective systems are the most dangerous meteorological structures. They generate many material and human incidents and accidents. They are potentially very dangerous for certain human activities: aviation, navigation, offshore activities (offshore oil drilling, offshore wind turbines, etc.).

Convective systems may appear on land or at sea. The largest convective systems are found in tropical areas, in particular in oceanic tropical areas.

To date, the detection and forecasting of convective systems, in particular in tropical oceanic areas, have been very poor due in particular to the lack of data, lack of knowledge of the associated physics, and the rapid evolution of convective systems.

One of the aims of the invention is to propose a meteorology method that makes it possible to detect and/or predict the occurrence of a convective system and/or the characteristics of such a convective system, reliably, and that is easy to implement.

To that end, the invention relates to a meteorology method implemented by computer for detecting and/or forecasting convective atmospheric systems in the atmosphere of a planet according to radiance data acquired by means of at least one radiance sensor, the radiance data being representative of the radiance emitted by a surface of the planet and/or clouds present in the atmosphere, and/or radar surface data acquired on the surface of the planet by means of at least one radar, the radar data being representative of the state of the surface of the planet, the method comprising
the detection of a convective atmospheric system jointly according to both radiance data and radar surface data, and/or
the digital forecasting of a convective atmospheric system with digital assimilation of the radar surface data or jointly according to both the radiance data and the radar surface data.

The radiance data provides information on the presence of clouds in the monitored geographic zone and on the characteristics of these clouds. In particular, the radiance data make it possible to determine the content in terms of water and different types of hydrometeor of these clouds, as well as the vertical extension and the vertical and/or horizontal extension variation speed of these clouds.

The radar data on a certain frequency band provide information on the surface of the planet (ground or sea) independently of the presence of clouds in the monitored geographic zone. This information in particular makes it possible to calculate characteristics of the wind on the surface of the planet as well as, in the case of a maritime zone, sea conditions.

The combination of radiance data and radar surface data makes it possible to detect a convective system reliably.

The radiance data and the radar surface data can be taken into account, in addition to other conventional meteorological and oceanographic data like those provided by the major weather forecasting centers, to provide a digital forecast of a convective system, also reliably.

According to specific embodiments, the meteorology method comprises one or more of the following optional features, considered alone or according to any technically possible combination(s):
the detection is performed according to a cloud signature of the convective atmospheric system, the vertical extension of the convective atmospheric system and/or the variation speed of the vertical and/or horizontal extension of clouds of the convective atmospheric system calculated based on radiance data;
the detection is performed according to wind characteristics on the surface of the geographic zone calculated based on radar surface data;
the detection of a convective atmospheric system according to radiance data and radar surface data triggers the performance of a digital forecast of the convective atmospheric system;
the digital forecast of a convective atmospheric system is performed according to meteorological data, oceanographic data, radiance data and/or radar surface data;
the method comprises the digital assimilation of meteorological data, oceanographic data, radiance data and/or radar surface data to perform the digital forecast;
the radar surface data are acquired via at least one synthetic aperture radar;
the radiance data are provided by at least one radiance sensor on board a satellite, an aircraft, a ship, an offshore station or located in a ground station, and/or the radar surface data are provided by at least one radar on board a satellite, an aircraft, a ship, an offshore station or located in a ground station.

The invention also relates to a computer program product comprising code instructions for carrying out a meteorology method as defined above when it is executed on a computer.

The invention further relates to an electronic meteorology device configured to carry out a meteorology method as defined above, comprising an acquisition module for acquiring radiance data and radar surface data, as well as a detection module configured to detect a convective system and/or a simulation module configured to carry out the digital forecasting of a convective atmospheric system.

The invention and its advantages will be better understood upon reading the following description, provided solely as an example, and done in reference to the appended drawings, in which:

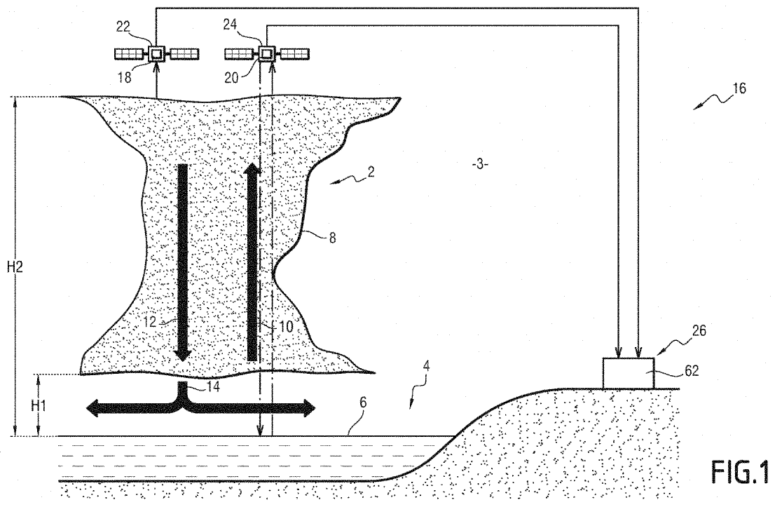

FIG. 1 is a schematic illustration of a convective system and a meteorology system configured for detecting and/or forecasting a convective system;

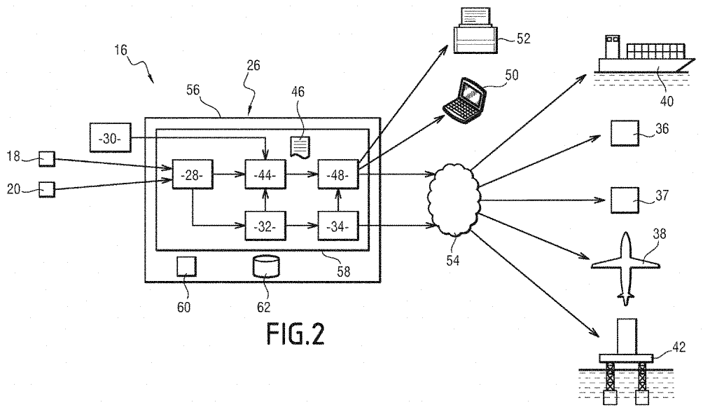

FIG. 2 is a schematic illustration of the meteorology system; and

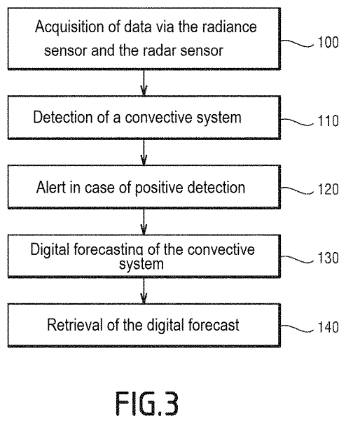

FIG. 3 is a flowchart of a meteorology method implemented by computer.

The convective atmospheric system 2 (or convective system 2) illustrated in FIG. 1 is formed in an atmosphere 3 surrounding a planet 4, here the Earth, the planet 4 having a surface 6.

The convective system 2 is located in a geographical zone, here a maritime zone. The considered surface 6 is therefore the surface of the sea. In a variant, it is located in a continental zone and the surface 6 is the ground. During its evolution, the convective system 2 can move on the surface 6 of the planet 4 and change size vertically and/or horizontally.

The convective system 2 comprises clouds 8. The illustrated clouds 8 correspond to a mature convective system 2. The clouds 8 form a Cumulonimbus (Cb). They are in the form of a cloud column with a wide apex, or an “anvil” shape. When the evolution of the convective system 2 is less advanced, the clouds 8 have the cumulus shape with less substantial vertical extensions, of the Cumulus Congestus type.

The clouds 8 extend vertically between a first altitude H1 of several hundreds of meters from the surface 6 and a second altitude H2 of several kilometers from the surface 6.

The convective system 2 has an intense meteorological activity characterized by ascending winds 10 and descending winds 12 that can be very violent.

The ascending winds 10 are generated by hot air that rises from the base toward the apex of the convective system 2 by convection effect. Conversely, the descending winds 12 are generated by the turbulent cold air that descends toward the base of the convective system 2.

The descending winds 12 generate powerful winds and gusts of wind 14 on the surface 6 of the planet 4 when they encounter this surface 6, by horizontal deflection of the descending winds 12. These winds and gusts of wind 14 can prove dangerous for certain human activities: aviation, navigation, offshore facilities (offshore oil drilling, offshore wind turbines, etc.).

A meteorology system 16 comprises at least one radiance sensor 18, and/or at least one radar 20 and at least one electronic meteorology device 26 configured to detect and/or forecast a convective system based on radiance data and/or radar data respectively provided by the radiance sensor 18 and/or by the radar 20.

A single radiance sensor 18 on board an observations satellite 22 is shown in FIG. 1. However, the meteorology system 16 can comprise one or several radiance sensors 18. Furthermore, each radiance sensor 18 can be on board a satellite, an aircraft, a ship, an offshore station or located in a ground station.

A single radar 20 on board an observations satellite 24 is shown in FIG. 1. However, the meteorology system 16 can comprise one or several radars 20. Furthermore, each radar 20 can be on board a satellite, an aircraft, a ship, an offshore station or located in a ground station.

Furthermore, a same vehicle, for example a same observations satellite 22, 24, can carry one or several radiance sensor(s) 18 and/or one or several radar(s) 20.

An observation satellite 22, 24 is geostationary and/or describes an orbit around the planet 4, in particular a polar orbit.

The radiance sensor 18 is configured to capture the radiances emitted by the planet 4 and its atmosphere 3. The radiance sensor 18 is for example a scanning radiometer.

The radiance data obtained via the radiance sensor 18 represent the radiances emitted by the planet 4 and by its atmosphere 3.

The radiances emitted by the planet 4 and its atmosphere 3 in a considered geographic zone depend on the clouds and the quantity of water (liquid, vapor, ice) present in the atmosphere as well as characteristics of these clouds and hydrometeors in liquid, vapor or solid (ice) phase present in these clouds, in the considered zone.

The radiance data therefore make it possible in particular to detect the presence of clouds, their hydrometeor contents, their vertical extension and their vertical and/or horizontal extension variation speed, in a geographical zone. A vertical and/or horizontal extension variation speed is for example determined from a series of successive radiance data.

It is possible to use one or several radiance sensors 18 sensitive to ultraviolet (UV), visible (Vis), infrared (IR) and/or microwave (MO) rays.

In one preferred embodiment, the meteorology system 16 comprises at least one radiance sensor 18 sensitive to infrared (IR) rays.

The radiance data for example comprise the brightness temperature at the apex of the clouds 8. This brightness temperature is deduced from the infrared rays emitted upward, from the clouds 8, which depend on the vertical extensions of these clouds 8. The greater the vertical extension is, the lower the temperature of the apex of the clouds is. Thus, the infrared rays of the clouds 8 are correlated with their vertical extensions. The difference between two successive measurements makes it possible to determine the vertical and/or horizontal extension variation speed.

Each radar 20 is configured to provide radar data representative the surface 6 of the planet 4, in particular data representative the surface condition of the sea in a maritime zone.

Each radar 20 is configured to measure a radar ray (or radar echo) reflected by the surface 6 of the planet 4.

Each radar 20 comprises a radar transmitter to emit incident radar rays toward the surface 6 of the planet 4 and a radar receiver to recover a radar ray (or radar echoes) reflected by the surface 6 of the planet 4.

Preferably, each radar 20 is configured to provide radar data representative the surface 6 of the planet 4 through the clouds 8. It is possible to use one or several synthetic aperture radar(s) 20, which makes it possible to measure, with greater precision, a radar echo of the surface 6 of the planet 4 through the clouds 8, even if they only partially pass through the clouds.

Furthermore, the used radar(s) 20 can be in bands C, X, Ku, K and/or W, or any other band making it possible to reconstitute the condition of the surface 6 of the planet 4.

In one specific embodiment, the meteorology system 16 comprises at least one synthetic aperture radar 20 in C bands, preferably on board a polar orbit observation satellite.

The radar surface data in particular make it possible to calculate one or several characteristic(s) of the wind on the surface 6 of the planet 4.

In a maritime zone, knowing the surface condition of the sea (roughness) makes it possible to deduce characteristics therefrom of the wind on the surface of the sea. The stronger the wind is, the more agitated the sea is and the greater the roughness of the surface 6 is. The radar data make it possible to determine the roughness of the surface 6 and, by inversion, to deduce therefrom the wind and the waves on the surface 6.

As shown in FIG. 2, the meteorology device 26 comprises an acquisition module 28 configured to acquire radiance data provided by the radiance sensor 18 and radar surface data provided by the radar 20. The acquisition module 28 is configured to receive the radiance data and the radar data coming from the radiance sensor 18 and the radar sensor 20.

The meteorology device 26 comprises a detection module 32 configured to detect the presence of a convective system based on radiance data and radar surface data acquired by the acquisition module 28.

The radiance data and the radar surface data acquired and used to detect a convective system 2 are used directly, without prior processing by a meteorological forecasting center.

The detection module 32 is for example configured to evaluate the vertical extension and/or the vertical and/or horizontal extension variation speed of the clouds in a geographical zone based on radiance data, and to calculate at least one characteristic of the wind on the surface 6 of the considered geographical zone based on radar data, for example a speed of the wind on the surface 6 of the planet 4.

Typically, the combination of powerful winds and gusts of wind 14 on the surface 6 of the sea and clouds 8 of large vertical extension in a zone is characteristic of the presence of a convective system 2. The winds and gusts of wind 14 are in particular stronger below and near the convective system 2 than in the areas further from the convective system 2. The combination of radiance data at altitude and radar surface data therefore allows a very reliable detection of a convective system.

In one embodiment, the detection module 32 is configured to determine that a convective system 2, in formation or in a mature phase, is present in a geographical zone based on a predetermined detection function indicating the existence of a convective system based on the one hand on characteristics of the wind on the surface 6 of the considered geographical zone, and on the other hand on the vertical extension of clouds 8 above the zone and/or a vertical and/or horizontal extension variation speed of the clouds 8 above the considered geographical zone.

In one embodiment, the detection module 32 determines that a convective system 2 is present in a geographical zone if, cumulatively, the characteristics of the wind on the surface 6 of the considered zone are above thresholds and if the vertical extension of the clouds corresponding to the convective system 2 above the considered geographical zone is above a vertical extension threshold and/or if the vertical extension variation speed is above a variation speed threshold.

Optionally, the meteorology device 26 comprises an alert module 34 configured to generate an alert signal in case of detection of a convective system 2 by the detection module 32.

The alert signal is for example emitted in the form of a radio signal, a light signal (visible, laser, etc.), a message sent via a telephone network (SMS, MMS, etc.) or a message sent via the Internet in any form (email, webpage, etc.).

The alert signal is for example sent to a user such as a meteorological forecasting body 36 or a civilian (industrial or institutional) or military command operational center 37, an aircraft 38, a ship 40 or an offshore facility 42 present in, moving toward, or likely to move toward the zone in which the convective system 2 has been detected.

The meteorology device 26 here comprises a simulation module 44 configured to calculate a digital forecast of the detected convective system 2.

The digital forecast is a digital simulation done using a digital model that is executed by the simulation module 44. The digital forecast predicts the future evolution of the convective system 2 over time. The digital forecast is for example given for a period from one to several tens of hours, or more.

The digital forecast is done by digital simulation from meteorological data and conventional oceanographic data provided by a meteorological and oceanographic data source 30.

The meteorological data and the conventional oceanographic data are for example obtained from a network of meteorological stations, meteorological satellites, measuring instruments on board vehicles (aircraft, ships, etc.), received raw and/or after processing by one or several meteorological forecasting center(s) (digital meteorological analyses and forecasts on grid). Each meteorological forecasting center is for example worldwide, continental, national or regional depending on the geographical jurisdiction zone for which it provides the data.

The meteorological data and the conventional oceanographic data are for example obtained from the World Meteorological Organization, in particular the World Observation System (WOS) and/or the Global Data Processing System (GDPS), for example via the Global Telecommunication System (GTS).

Optionally, the digital forecast is further performed according to radiance data and/or radar surface data respectively provided by the radiance sensor 18 and the radar 20, in addition to meteorological data and conventional oceanographic data.

Preferably, the radiance data and the radar data acquired and used for the forecasting of a convective system, in addition to the meteorological data and the oceanographic data, are used directly, without prior processing, by a meteorological forecasting center.

The simulation module 44 therefore uses, as input data, conventional meteorological and oceanographic data, and optionally, the radiance data and/or the radar surface data, and provides, as output, a digital forecast 46 representative the convective system 2.

The conventional meteorological and oceanographic data, and optionally the radiance data and/or the radar surface data, are for example in particular used as initial conditions for the convective system digital model, the simulation being done from these initial conditions.

A convective system 2 is a three-dimensional meteorological structure. The simulation module 44 is preferably configured to produce a three-dimensional simulation of the convective system 2.

In one embodiment, the simulation module 44 is configured to update the digital forecast based on meteorological data and conventional oceanographic data, and optionally radiance data and/or radar surface data, acquired after the beginning of the digital simulation.

Advantageously, to that end, the simulation module 44 is configured for the digital assimilation of data, in particular for the assimilation of meteorological data and conventional oceanographic data, and optionally, radiance data and/or radar surface data.

The assimilation of data makes it possible to account for differences between data provided for a given moment and data observed at this same moment to update and correct the digital forecast.

Optionally, the meteorology device 26 comprises a retrieval module 48 to retrieve the result of the simulation.

In one embodiment, the retrieval module 48 is configured to generate bulletins from the result of the simulation, and display them on a viewing screen 50 and/or print them on a printer 52.

Optionally or in a variant, the retrieval module 48 is configured to send the simulation results and/or a bulletin via a communication network 54 to one or several users such as a meteorological forecasting body 36 or a civilian (industrial or institutional) or military command operational center 37, an aircraft 38, a ship 40 or an offshore facility 42 present in, moving toward, or likely to move toward the zone in which the convective system 2 has been detected.

The meteorology device 26 comprises an information processing unit 56 comprising a computer memory 58 and one or several processors 60 associated with the memory 58.

In the example of FIG. 2, the acquisition module 28, the detection module 32, the alert module 34, the simulation module 44 and the retrieval module 48 are each made in the form of a software application comprising computer code instructions recorded in the memory 58 and executable by the processor(s) 60.

In a variant that is not shown, the acquisition module 28, the detection module 32, the alert module 34, the simulation module 44 and/or the retrieval module 48 is (are) implemented in the form of at least one programmable logic component, such as an FPGA (Field Programmable Gate Array), or in the form of a specific integrated circuit, such as an ASIC (Applications Specific Integrated Circuit).

Preferably, the meteorology system 16 comprises a computer storage device 62 (e.g., a storage server or hard drive) configured to store radiance data and radar data provided by each radiance sensor 18 and each radar 20, optionally additional meteorological and oceanographic data, as well as results of digital simulations.

The meteorology device 26 is for example located in a land-based facility, in an offshore facility or on board a vehicle (aircraft, drone, ship, land-based vehicle, etc.).

In one specific example, the meteorology device 26 is located in a land-based weather monitoring station 62. The meteorology device 26 receives the radiance data and the radar data collected by the radiance sensor 18 and the radar 20.

The operation of the meteorology device 26 will now be described in reference to FIG. 3 illustrating a flowchart of a meteorology method implemented by computer.

During an acquisition step 100, the acquisition module 28 acquires radiance data and radar data relative to a geographical zone, respectively obtained by the radiance sensor 18 and the radar 20.

Next, during a detection step 110, the detection module 32 detects the presence of a convective system in the considered geographical zone based on radiance data and/or radar surface data acquired during the acquisition step 100.

To that end, the detection module 32 calculates the vertical extension of the clouds and/or their vertical and/or horizontal extension variation speed in the considered geographical zone from radiance data, and calculates at least one characteristic of the wind on the surface 6 of the planet 4 in the considered geographical zone based on radar surface data, and determines the presence or absence of a convective system 2 based on the calculated vertical extension and/or the calculated vertical and/or horizontal extension variation speed and each calculated characteristic of the wind.

Optionally, during an alert step 120, the alert module 34 emits an alert signal if the presence of a convective system 2 has been detected.

When a convective system 2 is detected, a simulation step 130 is triggered.

During a simulation step 130, the simulation module 44 calculates a digital forecast of the detected convective system 2, based on conventional meteorological and oceanographic data, and optionally, based on radiance data and/or radar surface data provided by the radiance sensor 18 and the radar 20, using a digital model.

Optionally, the simulation module 44 calculates the forecast with data assimilation, in particular conventional meteorological and oceanographic data, radiance data and/or radar surface data acquired over the course of the evolution of the convective system 2, in particular after the detection of the convective system 2 and after the startup of the digital simulation.

Optionally, during a retrieval step 140, the retrieval module 48 retrieves the result of the simulation or an associated bulletin, by displaying, printing and/or sending to a remote system, for example an Internet server or a user such as a meteorological forecasting body 36, a command operational center 37, an aircraft 38, ship 40 or an offshore facility 42.

In a variant, the meteorology method comprises the detection of a convective system, and the sending of an alert signal, but does not comprise digital forecasting and retrieval. The meteorology method only makes it possible to detect a convective system and to alert, but not to predict its evolution.

The meteorology method and device make it possible to detect a convective system and/or to predict the evolution of a convective system reliably, by crossing radiance data with radar surface data.

The radiance data and the radar surface data make it possible to detect a convective system and to emit an alert, but can also serve as initial conditions making it possible to establish a reliable digital forecast by digital simulation, via a digital model. The forecast can be done several hours out with a high degree of confidence.

The meteorology method and device make it possible to alert the presence of a convective system in a determined zone, which allows an aircraft or a ship to avoid the zone in question, or an offshore facility to place itself in a secure configuration.

The detection and forecasting are done from data obtained remotely without having to obtain data measured in situ on the surface of the sea or in the convective system.

The digital forecasting of the convective system with data assimilation, potentially including the radiance data and/or the radar surface data, makes it possible to correct the digital forecast as the convective system evolves to improve the precision.

The meteorological method and device have been described more specifically in an application to the detection and forecasting of a convective system on the Earth's surface.

The meteorological monitoring and/or forecasting method and device are more generally applicable to any planet having an active atmosphere, such as Mars.

Furthermore, the use of radiance data and/or radar surface data for the digital forecasting of a convective system makes it possible to obtain a reliable digital forecast that is easy to implement independently of a detection done previously with these radiance data and these radar surface data.

Thus, the invention also generally relates to a meteorology method in which a digital forecast of a convective system is done based on radiance data and radar surface data, used as input data, for example for initial conditions, and/or as assimilation data.

1. A meteorology method implemented by computer for detecting and/or forecasting convective atmospheric systems in the atmosphere of a planet according to radiance data acquired by means of at least one radiance sensor, the radiance data being representative of the radiance emitted by a surface of the planet and/or of clouds present in the atmosphere, and/or of radar surface data acquired on the surface of the planet by means of at least one radar, the radar data being representative of the state of the surface of the planet, the method comprising:
the detection of a convective atmospheric system jointly according to both radiance data and radar surface data, and/or
the digital forecasting of a convective atmospheric system with digital assimilation of the radar surface data or jointly according to both the radiance data and the radar surface data.

2. The meteorology method according to claim 1, wherein the detection is performed according to a cloud signature of the convective atmospheric system, the vertical extension of the convective atmospheric system and/or the variation speed of the vertical and/or horizontal extension of clouds of the convective atmospheric system calculated based on radiance data.

3. The meteorology method according to claim 1, wherein the detection is performed according to wind characteristics on the surface of the geographic zone calculated based on radar surface data.

4. The meteorology method according to claim 1, wherein the detection of a convective atmospheric system according to radiance data and radar surface data triggers the performance of a digital forecast of the convective atmospheric system.

5. The meteorology method according to claim 1, wherein the digital forecast of a convective atmospheric system is performed according to meteorological data, oceanographic data, radiance data and/or radar surface data.

6. The meteorology method according to claim 1, comprising the digital assimilation of meteorological data, oceanographic data, radiance data and/or radar surface data to perform the digital forecast.

7. The meteorology method according to claim 1, wherein the radar surface data are acquired via at least one synthetic aperture radar.

8. The meteorology method according to claim 1, wherein the radiance data are provided by at least one radiance sensor on board a satellite, an aircraft, a ship, an offshore station or located in a ground station, and/or the radar surface data are provided by at least one radar on board a satellite, an aircraft, a ship, an offshore station or located in a ground station.

9. A non-transitory computer readable medium having a program stored thereon for executing a computer to perform the meteorology method according to claim 1.

10. An electronic meteorology device configured to carry out a meteorology method according to claim 1, comprising an acquisition module for acquiring radiance data and radar surface data, as well as a detection module configured to detect a convective system and/or a simulation module configured to carry out the digital forecasting of a convective atmospheric system.
